(19) United States
(12) Patent Application Publication
(10) Pub. No.: US 2023/0029064 A1
(43) Pub. Date: Jan. 26, 2023

(54) Methodology for Achieving Highly Scalable and Distributed Secured Connectivity per IPSEC Tunnel

(71) Applicant: Parallel Wireless, Inc., Nashua, NH (US)

(72) Inventors: Anoop Gupta, Pune (IN); Sanjay Harwani, Pune (IN)

(21) Appl. No.: 17/873,091

(22) Filed: Jul. 25, 2022

Related U.S. Application Data
(60) Provisional application No. 63/224,929, filed on Jul. 23, 2021.

(51) Int. Cl. H04L 9/40; H04L 12/46

(52) U.S. Cl. CPC H04L 63/0485; H04L 12/4633; H04L 2212/00

(57) ABSTRACT

Methods, systems and computer readable media are disclosed for providing scalable and secured connectivity per Internet Protocol Security (IPSEC) tunnel. In one embodiment a method includes spreading Encapsulating Security Payload (ESP) encryption for a same IPSEC tunnel across multiple backend application servers; and processing application flows using decrypted packets by embedding the Application Server instance-id in ESP and application packets for correlation with application packet flows.

### CROSS-REFERENCE TO RELATED APPLICATIONS

This application claims priority under 35 U.S.C. § 119(e) to U.S. Provisional Pat. App. No. 63/224,929, filed Jul. 23, 2021, titled “Methodology for Achieving Highly Scalable and Distributed Secured Connectivity per IPSEC Tunnel” which is hereby incorporated by reference in its entirety for all purposes. This application also hereby incorporates by reference, for all purposes, each of the following U.S. Patent Application Publications in their entirety: US20170013513A1; US20170026845A1; US20170055186A1; US20170070436A1; US20170077979A1; US20170019375A1; US20170111482A1; US20170048710A1; US20170127409A1; US20170064621A1; US20170202006A1; US20170238278A1; US20170171828A1; US20170181119A1; US20170273134A1; US20170272330A1; US20170208560A1; US20170288813A1; US20170295510A1; US20170303163A1; and US20170257133A1. This application also hereby incorporates by reference U.S. Pat. No. 8,879,416, “Heterogeneous Mesh Network and Multi-RAT Node Used Therein,” filed May 8, 2013; U.S. Pat. No. 9,113,352, “Heterogeneous Self-Organizing Network for Access and Backhaul,” filed Sep. 12, 2013; U.S. Pat. No. 8,867,418, “Methods of Incorporating an Ad Hoc Cellular Network Into a Fixed Cellular Network,” filed Feb. 18, 2014; U.S. patent application Ser. No. 14/034,915, “Dynamic Multi-Access Wireless Network Virtualization,” filed Sep. 24, 2013; U.S. patent application Ser. No. 14/289,821, “Method of Connecting Security Gateway to Mesh Network,” filed May 29, 2014; U.S. patent application Ser. No. 14/500,989, “Adjusting Transmit Power Across a Network,” filed Sep. 29, 2014; U.S. patent application Ser. No. 14/506,587, “Multicast and Broadcast Services Over a Mesh Network,” filed Oct. 3, 2014; U.S. patent application Ser. No. 14/510,074, “Parameter Optimization and Event Prediction Based on Cell Heuristics,” filed Oct. 8, 2014, U.S. patent application Ser. No. 14/642,544, “Federated X2 Gateway,” filed Mar. 9, 2015, and U.S. patent application Ser. No. 14/936,267, “Self-Calibrating and Self-Adjusting Network,” filed Nov. 9, 2015; U.S. patent application Ser. No. 15/607,425, “End-to-End Prioritization for Mobile Base Station,” filed May 26, 2017; U.S. patent application Ser. No. 15/803,737, “Traffic Shaping and End-to-End Prioritization,” filed Nov. 27, 2017, each in its entirety for all purposes, having attorney docket numbers PWS-71700US01, US02, US03, 71710US01, 71721US01, 71729US01, 71730US01, 71731US01, 71756US01, 71775US01, 71865US01, and 71866US01, respectively. This document also hereby incorporates by reference U.S. Pat. Nos. 9,107,092, 8,867,418, and 9,232,547 in their entirety. This document also hereby incorporates by reference U.S. patent application Ser. No. 14/822,839, U.S. patent application Ser. No. 15/828,427, U.S. Pat. App. Pub. Nos. US20170273134A1, US20170127409A1 in their entirety.

### BACKGROUND

Providing end-to-end network security is an important aspect and is generally achieved by using Internet Protocol Security (IPSEC) Gateways at the centralized nodes. IPSEC tunnel is formed end-to-end using the publicly exposed IP of each party and forms Security-Association (SA) which is identified by Security Parameter Index (SPI), an IP-address and a security protocol (Authentication Header (AH) or Encapsulating Security Payload (ESP)).

While scaling up the system, we must take care of scaling aspect of IPSEC if it is deployed with the application. The single end-to-end IPSEC-tunnel is hosted on one of the servers/containers. Hence, the overall throughput is limited by the capacity and load on this server/container and hence, one server may become the bottleneck as it will typically not scale for the throughput requirement of single IPSEC pipe. Sometimes, the application flows also plays an important role here in the sense the decrypted ESP packets should land on a specific backend server only as the corresponding Application flows for that decrypted application Data is present on that backend server and hence, we are constraint for solving these two use-cases together.

### SUMMARY

Methods, systems and computer readable media are disclosed for providing scalable and secured connectivity per Internet Protocol Security (IPSEC) tunnel. This is achieved by employing multiple equal number of security-associations during IPSEC-creation at both involved party and a methodology to make use of plurality of back-end servers matching the number of Security-Associations exchanged for the same IPSEC-tunnel for both encryption and decryption of ESP packets and embedding common identifier at ESP packet for correlation with the Application packets flows like SCTP, GTPU, etc.

In one embodiment a method includes spreading Encapsulating Security Payload (ESP) encryption for a same IPSEC tunnel across multiple backend application servers; and processing application flows using decrypted packets by embedding the Application Server instance-id in ESP and application packets for correlation with application packet flows.

In another example embodiment a system for providing scalable and secured connectivity per Internet Protocol Security (IPSEC) tunnel includes an IPSEC control element exchanging IPSEC signaling with a peer; a traffic load balancer in communication with the IPSEC control element and receiving IPSEC ESP packets from the peer; a plurality of Application servers in communication with the IPSEC control element and in communication with the load balancer; wherein the system spreads Encapsulating Security Payload (ESP) encryption for a same IPSEC tunnel across the plurality of backend application servers; and wherein the system processes application flows using decrypted packets by embedding the Application Server instance-id in ESP and application packets for correlation with application packet flows.

In another embodiment a non-transitory computer-readable medium includes instructions for providing scalable and secured connectivity per Internet Protocol Security (IPSEC) tunnel which, when executed, cause the system to perform steps comprising spreading Encapsulating Security Payload (ESP) encryption for a same IPSEC tunnel across multiple backend application servers; and processing application flows using decrypted packets by embedding the Application Server instance-id in ESP and application packets for correlation with application packet flows.

### BRIEF DESCRIPTION OF THE DRAWINGS

FIGS. 1A and 1B are a call flow diagram of a scalable IPSEC security flow, in accordance with some embodiments.

FIG. 2 is a block diagram of a scalable system, in accordance with some embodiments.

FIG. 3 is a schematic network architecture diagram for 3G and other-G prior art networks.

FIG. 4 is an enhanced eNodeB for performing the methods described herein, in accordance with some embodiments.

FIG. 5 is a coordinating server for providing services and performing methods as described herein, in accordance with some embodiments.

### DETAILED DESCRIPTION

In a scaled deployment, multiple servers/containers working in tandem to solve the scaling requirement of a big eco-system by doing the horizontal scaling in a distributed and virtualized or cloud-native environment. This typically requires many back-end servers/containers running these services and typically requires Load Balancer at the front to distribute the inbound traffic across these backend servers/containers.

While scale up the system, we must take care of scaling aspect of IPSEC if it is deployed with the application. We also typically want to make use of single IPSEC-tunnel end-to-end instead of exposing all these backend-servers/containers and making individual IPSEC association with all these back-end servers/containers with every remote Peer.

The single end-to-end IPSEC-tunnel is hosted on one of the servers/containers. Hence, the overall throughput is limited by the capacity and load on this server and hence, one server may become the bottleneck as it will typically not scale for the throughput requirement of single IPSEC pipe.

There are solutions like moving out IPSEC functionality outside and do the IPSEC encryption, decryption on that server and only application data is processed on the backend server/container. But again, the shortcoming here is this single server itself will not be able to scale to cater to the requirement of high throughput per IPSEC-pipe across plurality of such Peers. Also, there are use cases where we require scaling and high throughput per IP at runtime.

Sometimes, the application flows also plays an important role here in the sense the decrypted ESP packets should land on a specific backend server only as the corresponding Application flows for that decrypted application Data is present on that backend server and hence, we are constraint for solving these two use-cases together.

The application-servers may run as containers or Kubernetes pods in the cloud native environment. For scale-up during peak hours or high traffic, we may have to spawn more such containers or pods across multiple nodes/VMs. However, the moment we add IPSEC for end-to-end L3 security, it has certain implications on scaling aspect of individual IPSEC-pipe with the peer because single IPSEC-connection is hosted on one of the container/pods.

IPSEC support multiple child Security Association (SA) per IPSEC tunnel. Each SA is identified by SPI, IP-address and a security protocol. Here the focus in on multiple SA exchanged for ESP.

The proposal here is to make use of the support of multiple child Security Associations (SA) per IPSEC connection at both involved party and distribute these equal number of pair of SAs, one for uplink and other for downlink, one pair of SA to one of the backend containers/pod hosting the Applications like GTPU, SCTP etc. and additionally performing IPSEC encryption and decryption. So, the idea is to devise a methodology that the ESP encryption and decryption for same IPSEC-tunnel could also get uniformly spread across multiple backend application servers and the decrypted packets on an application server also has the corresponding application flows to process the application data by embedding the application server instance-id in ESP and Application packets like GTPU, SCTP, etc. e.g., if container/pod-1 is mapped to handle security association for peer-SA-1 for doing IPSEC encryption and self-SA-1 for doing the IPsec-decryption and then feeding the Application-Data to the Application-server hosting the application flows for this application-data packet. This could be achieved by embedding the server-instance-id in some headers like TE-Id for GTPU packets or verification-tag for SCTP packets and embed the same instance-id in Security Parameter Index (SPI) of Security-Association (SA).

While sending the Application-data, the peer needs to select the correct Server's Security Association from plurality of Server-SAs for IPSEC encryption because it should reach the correct backend-pod hosting the Application flows for this application Data. Peer will do this selection based on pre-configured correlation to fetch the server instance-id embedded in the Application packets like TE-Id in GTPU-packet or verification-tag in SCTP packet, look out for same instance-id embedded in SPI of Security-associations (SA) exchanged during the IPSEC-tunnel creation, figure out the SA and then use its SPI to encrypt the Application Data and send the ESP packet to Server.

At the Application-server side, as many application servers are using same sets of Virtual IP-address (VIP) for application, there is a need of an external Load-balancer to host these VIPs distribute the traffic to these backend-servers.

When the ESP packet is received at the Load balancer (LB), LB will check the SPI of the ESP packet and get the embedded instance-Id and route it to the backend Application container/pod. The backend Application container/pod is also capable of IPSEC enc-decryption and has prior knowledge of Security-Association (SA) via the information pushed to it by the IPSEC-controller on Server, the backend-Server is now able to decrypt the ESP packet, retrieves the application-data packet. Now, the Peer has ensured to use the embedded instance in TE-Id of GTPU-packet while selecting the Server's SA, the decrypted packet has reached the application server hosting the application flows and it will get processed.

Similarly, as while doing the IPSEC connection, we ensured that both the involved parties share the same number of Security-Association and mapped a pair of Uplink and Downlink Security-association to these backend Application servers, the backend Server will directly do the encryption using the SA of peer and send the encrypted packet to the peer.

So, using this methodology, we were able to make use of all the Application servers hosted on containers/pods across multiple nodes/VMs for both encryption and decryption and thus, could scale the solutions. While adding a new Application-Server during peak traffic hours, the IPSEC-controller will be informed to send rekey to refresh the association and add one more Security-Association to it. The peer will reciprocate it by adding one additional security-key in the rekey, and hence both the involved parties will have equal number of Security associations (SA) comprising of same IP-address, security keys, but different SPI which is the identifier for the ESP packet.

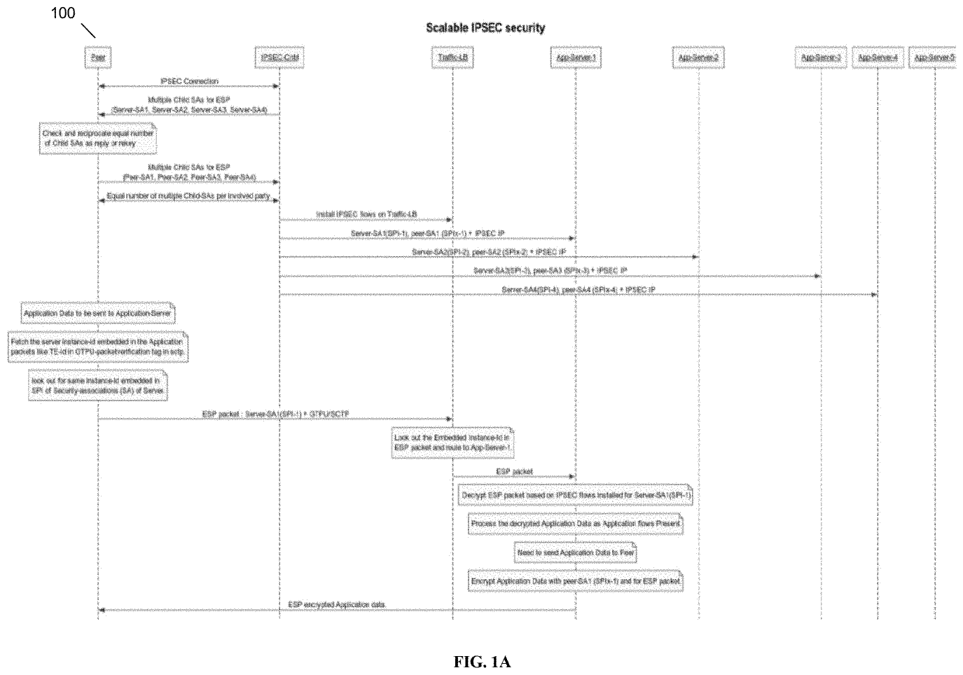

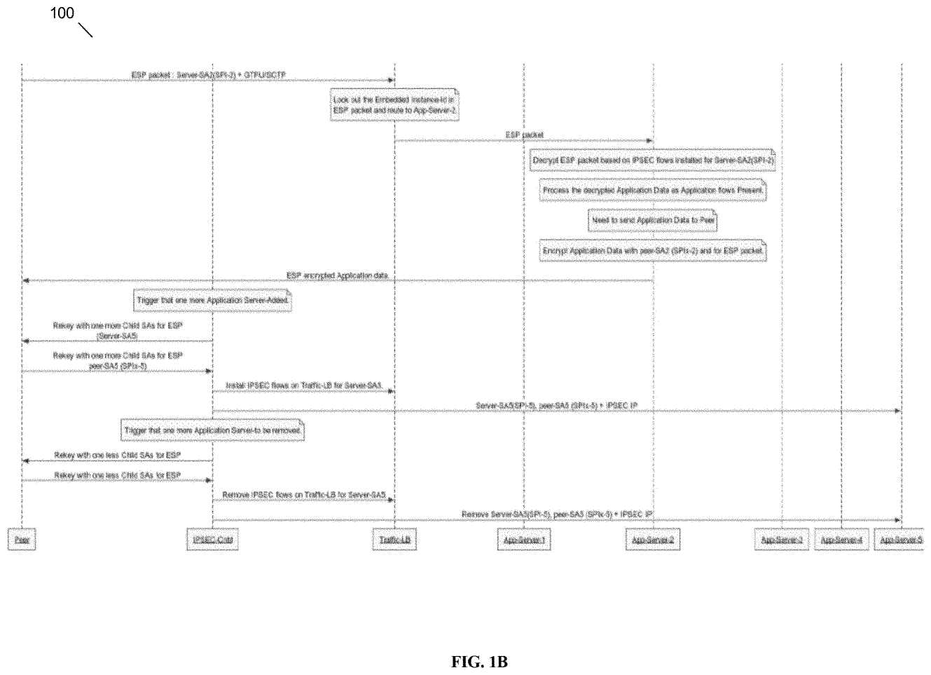

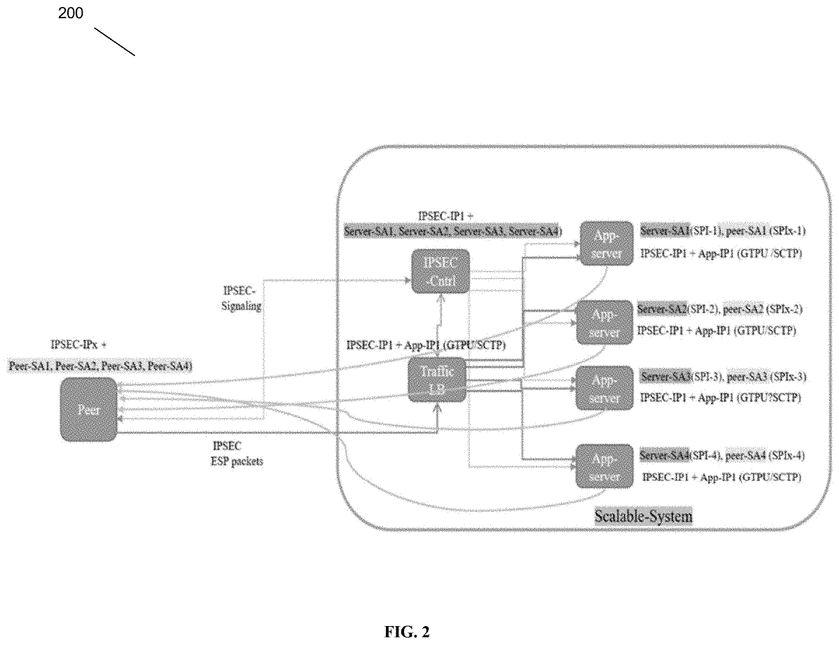

FIGS. 1a and 1B are a call flow diagram for scalable IPSEC security 100. A scalable IPSEC security association system is shown with multiple app servers, a traffic load balancer, and an IPSEC controller, as described additionally with reference to FIG. 2. In starting the connection, the peer node, upon receiving multiple child SAs and multiple server SAIs, checks and reciprocates an equal number of child SAs as reply or rekey. When traffic is passing through the IPSEC flows, the server instance ID is fetched from the embedded app packets (such as TEID, in GTPU packet verification tag in SCTP). The same instance ID may also be present in an SPI of a security association of a server. These instance IDs are used to generate the ESP packet going to the appropriate app server over the appropriate security association. Rekeying for increasing or decreasing child SAs is possible as shown.

FIG. 2 is a block diagram of a scalable system 200. In FIG. 2, in accordance with some embodiments, a same number of Security Associations is exchanged during IPSEC and rekey by each party for efficient load distribution of ESP packets for both encryption and decryption e.g., here 4 SAs per involved parties. The pair of SAs is distributed across App-server by IPSEC-Cntrl. The SPI and the Application-pkts have embedded the same Application-instance id to route the ESP packets to Same App-Server where the respective IPSEC-SA and Application-flows are installed. The peer node creates individual security associations (SAs) with each of multiple app servers; and, to facilitate this, each app server has a SA with its own server identifier (Server-SAI) and the same peer identifier (peer-SAI), as well as the shared IPSEC address information (IPSEC IP1 and App IP1). This will let the IPSEC-encryption and decryption performed at multiple backend App-Server for the same IPSEC-connection along with the Application data processing and shall be able to Scale Up/Down as needed for single IP use-cases as well. IPSEC signaling for each app server passes through, in this instance, a single IPSEC-cntrl node serving multiple app servers. ESP packets pass through traffic load balancer (LB) which load balances traffic toward the app servers.

This idea proposes a solution to the use case which will typically happen when we start scaling solutions across plurality of backend served listening on same IP for IPSEC and Applications. The proposed solution will help the seamless scaling per IPSEC connection by making use of multiple equal number of security association as the number of backend Applications servers and rekey to add more sets of pair of security association from both parties whenever we have to scale and add one more backend Application server.

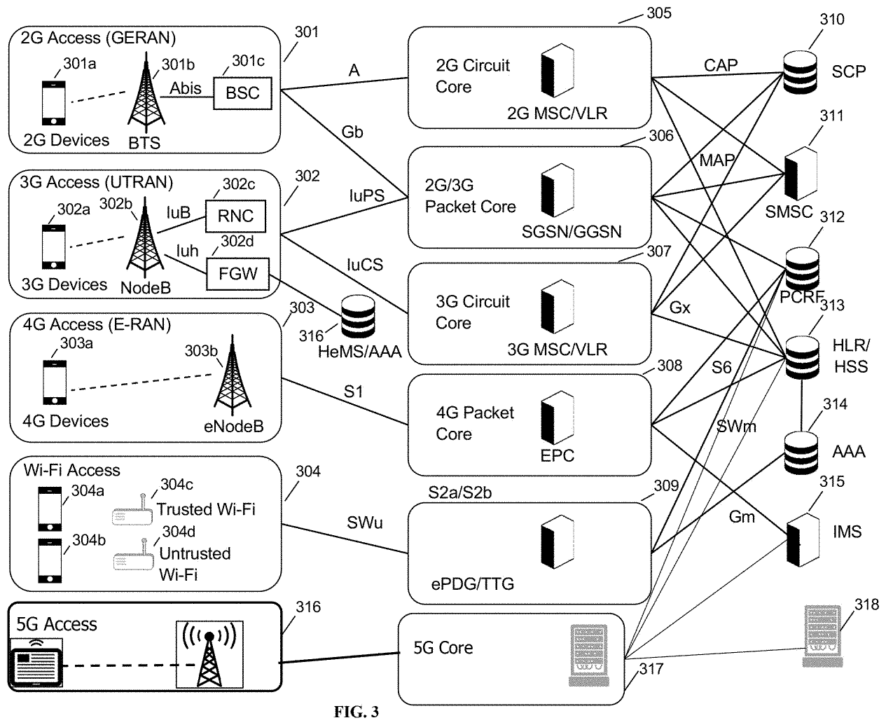

FIG. 3 is a schematic network architecture diagram for 3G and other-G prior art networks. The diagram shows a plurality of “Gs,” including 2G, 3G, 4G, 5G and Wi-Fi. 2G is represented by GERAN 301, which includes a 2G device 301a, BTS 301b, and BSC 301c. 3G is represented by UTRAN 302, which includes a 3G UE 302a, nodeB 302b, RNC 302c, and femto gateway (FGW, which in 3GPP namespace is also known as a Home nodeB Gateway or HNBGW) 302d. 4G is represented by EUTRAN or E-RAN 303, which includes an LTE UE 303a and LTE eNodeB 303b. Wi-Fi is represented by Wi-Fi access network 304, which includes a trusted Wi-Fi access point 304c and an untrusted Wi-Fi access point 304d. The Wi-Fi devices 304a and 304b may access either AP 304c or 304d. In the current network architecture, each “G” has a core network. 2G circuit core network 305 includes a 2G MSC/VLR; 2G/3G packet core network 306 includes an SGSN/GGSN (for EDGE or UMTS packet traffic); 3G circuit core 307 includes a 3G MSC/VLR; 4G circuit core 308 includes an evolved packet core (EPC); and in some embodiments the Wi-Fi access network may be connected via an ePDG/TTG using S2a/S2b. Each of these nodes are connected via a number of different protocols and interfaces, as shown, to other, non-“G”-specific network nodes, such as the SCP 330, the SMSC 331, PCRF 332, HLR/HSS 333, Authentication, Authorization, and Accounting server (AAA) 334, and IP Multimedia Subsystem (IMS) 335. An HeMS/AAA 336 is present in some cases for use by the 3G UTRAN. The diagram is used to indicate schematically the basic functions of each network as known to one of skill in the art, and is not intended to be exhaustive. For example, 5G core 317 is shown using a single interface to 5G access 316, although in some cases 5G access can be supported using dual connectivity or via a non-standalone deployment architecture.

Noteworthy is that the RANs 301, 302, 303, 304 and 336 rely on specialized core networks 305, 306, 307, 308, 309, 337 but share essential management databases 330, 331, 332, 333, 334, 335, 338. More specifically, for the 2G GERAN, a BSC 301c is required for Abis compatibility with BTS 301b, while for the 3G UTRAN, an RNC 302c is required for Iub compatibility and an FGW 302d is required for Iuh compatibility. These core network functions are separate because each RAT uses different methods and techniques. On the right side of the diagram are disparate functions that are shared by each of the separate RAT core networks. These shared functions include, e.g., PCRF policy functions, AAA authentication functions, and the like. Letters on the lines indicate well-defined interfaces and protocols for communication between the identified nodes.

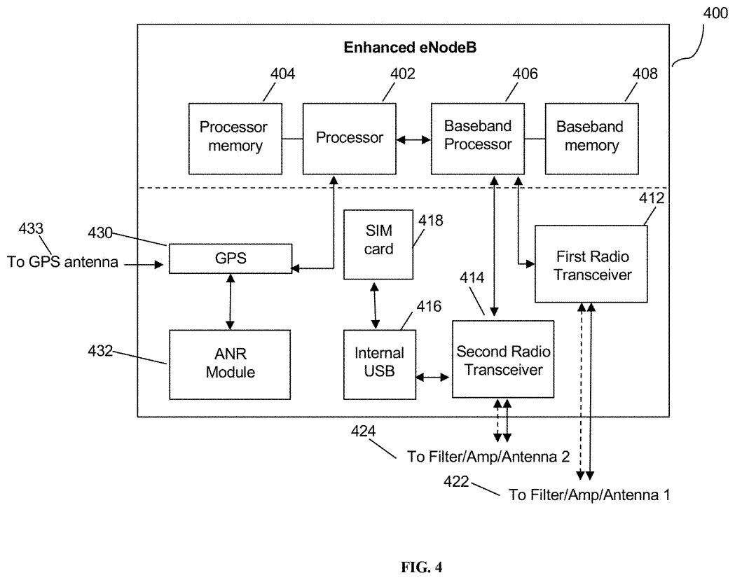

FIG. 4 is an enhanced eNodeB for performing the methods described herein, in accordance with some embodiments. Mesh network node 900 may include processor 402, processor memory 404 in communication with the processor, baseband processor 406, and baseband processor memory 408 in communication with the baseband processor. Mesh network node 400 may also include first radio transceiver 412 and second radio transceiver 414, internal universal serial bus (USB) port 416, and subscriber information module card (SIM card) 418 coupled to USB port 416. In some embodiments, the second radio transceiver 414 itself may be coupled to USB port 416, and communications from the baseband processor may be passed through USB port 416. The second radio transceiver may be used for wirelessly backhauling eNodeB 400.

Processor 402 and baseband processor 406 are in communication with one another. Processor 402 may perform routing functions, and may determine if/when a switch in network configuration is needed. Baseband processor 406 may generate and receive radio signals for both radio transceivers 412 and 414, based on instructions from processor 402. In some embodiments, processors 402 and 406 may be on the same physical logic board. In other embodiments, they may be on separate logic boards.

Processor 402 may identify the appropriate network configuration, and may perform routing of packets from one network interface to another accordingly. Processor 402 may use memory 404, in particular to store a routing table to be used for routing packets. Baseband processor 406 may perform operations to generate the radio frequency signals for transmission or retransmission by both transceivers 410 and 412. Baseband processor 406 may also perform operations to decode signals received by transceivers 412 and 414. Baseband processor 406 may use memory 408 to perform these tasks.

The first radio transceiver 412 may be a radio transceiver capable of providing LTE eNodeB functionality, and may be capable of higher power and multi-channel OFDMA. The second radio transceiver 414 may be a radio transceiver capable of providing LTE UE functionality. Both transceivers 412 and 414 may be capable of receiving and transmitting on one or more LTE bands. In some embodiments, either or both of transceivers 412 and 414 may be capable of providing both LTE eNodeB and LTE UE functionality. Transceiver 412 may be coupled to processor 402 via a Peripheral Component Interconnect-Express (PCI-E) bus, and/or via a daughtercard. As transceiver 414 is for providing LTE UE functionality, in effect emulating a user equipment, it may be connected via the same or different PCI-E bus, or by a USB bus, and may also be coupled to SIM card 418. First transceiver 412 may be coupled to first radio frequency (RF) chain (filter, amplifier, antenna) 422, and second transceiver 414 may be coupled to second RF chain (filter, amplifier, antenna) 424.

SIM card 418 may provide information required for authenticating the simulated UE to the evolved packet core (EPC). When no access to an operator EPC is available, a local EPC may be used, or another local EPC on the network may be used. This information may be stored within the SIM card, and may include one or more of an international mobile equipment identity (IMEI), international mobile subscriber identity (IMSI), or other parameter needed to identify a UE. Special parameters may also be stored in the SIM card or provided by the processor during processing to identify to a target eNodeB that device 400 is not an ordinary UE but instead is a special UE for providing backhaul to device 400.

Wired backhaul or wireless backhaul may be used. Wired backhaul may be an Ethernet-based backhaul (including Gigabit Ethernet), or a fiber-optic backhaul connection, or a cable-based backhaul connection, in some embodiments. Additionally, wireless backhaul may be provided in addition to wireless transceivers 412 and 414, which may be Wi-Fi 802.11a/b/g/n/ac/ad/ah, Bluetooth, ZigBee, microwave (including line-of-sight microwave), or another wireless backhaul connection. Any of the wired and wireless connections described herein may be used flexibly for either access (providing a network connection to UEs) or backhaul (providing a mesh link or providing a link to a gateway or core network), according to identified network conditions and needs, and may be under the control of processor 402 for reconfiguration.

A GPS module 430 may also be included, and may be in communication with a GPS antenna 432 for providing GPS coordinates, as described herein. When mounted in a vehicle, the GPS antenna may be located on the exterior of the vehicle pointing upward, for receiving signals from overhead without being blocked by the bulk of the vehicle or the skin of the vehicle. Automatic neighbor relations (ANR) module 432 may also be present and may run on processor 402 or on another processor, or may be located within another device, according to the methods and procedures described herein.

Other elements and/or modules may also be included, such as a home eNodeB, a local gateway (LGW), a self-organizing network (SON) module, or another module. Additional radio amplifiers, radio transceivers and/or wired network connections may also be included.

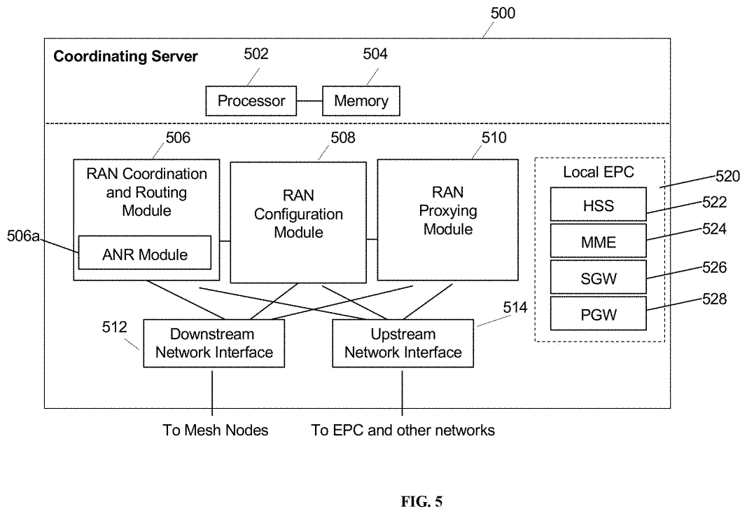

FIG. 5 is a coordinating server for providing services and performing methods as described herein, in accordance with some embodiments. Coordinating server 1000 includes processor 502 and memory 504, which are configured to provide the functions described herein. Also present are radio access network coordination/routing (RAN Coordination and routing) module 506, including ANR module 506a, RAN configuration module 508, and RAN proxying module 510. The ANR module 506a may perform the ANR tracking, PCI disambiguation, ECGI requesting, and GPS coalescing and tracking as described herein, in coordination with RAN coordination module 506 (e.g., for requesting ECGIs, etc.). In some embodiments, coordinating server 500 may coordinate multiple RANs using coordination module 506. In some embodiments, coordination server may also provide proxying, routing virtualization and RAN virtualization, via modules 510 and 508. In some embodiments, a downstream network interface 512 is provided for interfacing with the RANs, which may be a radio interface (e.g., LTE), and an upstream network interface 514 is provided for interfacing with the core network, which may be either a radio interface (e.g., LTE) or a wired interface (e.g., Ethernet).

Coordinator 500 includes local evolved packet core (EPC) module 520, for authenticating users, storing and caching priority profile information, and performing other EPC-dependent functions when no backhaul link is available. Local EPC 520 may include local HSS 522, local MME 524, local SGW 526, and local PGW 528, as well as other modules. Local EPC 520 may incorporate these modules as software modules, processes, or containers. Local EPC 520 may alternatively incorporate these modules as a small number of monolithic software processes. Modules 506, 508, 510 and local EPC 520 may each run on processor 502 or on another processor, or may be located within another device.

In 5GC, the function of the SGW is performed by the SMF and the function of the PGW is performed by the UPF. The inventors have contemplated the use of the disclosed invention in 5GC as well as 5G/NSA and 4G. As applied to 5G/NSA, certain embodiments of the present disclosure operate substantially the same as the embodiments described herein for 4G. As applied to 5GC, certain embodiments of the present disclosure operate substantially the same as the embodiments described herein for 4G, except by providing an N4 communication protocol between the SMF and UPF to provide the functions disclosed herein.

In any of the scenarios described herein, where processing may be performed at the cell, the processing may also be performed in coordination with a cloud coordination server. A mesh node may be an eNodeB. An eNodeB may be in communication with the cloud coordination server via an X2 protocol connection, or another connection. The eNodeB may perform inter-cell coordination via the cloud communication server when other cells are in communication with the cloud coordination server. The eNodeB may communicate with the cloud coordination server to determine whether the UE has the ability to support a handover to Wi-Fi, e.g., in a heterogeneous network.

Although the methods above are described as separate embodiments, one of skill in the art would understand that it would be possible and desirable to combine several of the above methods into a single embodiment, or to combine disparate methods into a single embodiment. For example, all of the above methods could be combined. In the scenarios where multiple embodiments are described, the methods could be combined in sequential order, or in various orders, as necessary.

Although the above systems and methods for providing interference mitigation are described in reference to the Long Term Evolution (LTE) standard, one of skill in the art would understand that these systems and methods could be adapted for use with other wireless standards or versions thereof.

The word “cell” is used herein to denote either the coverage area of any base station, or the base station itself, as appropriate and as would be understood by one having skill in the art. For purposes of the present disclosure, while actual PCIs and ECGIs have values that reflect the public land mobile networks (PLMNs) that the base stations are part of, the values are illustrative and do not reflect any PLMNs nor the actual structure of PCI and ECGI values.

In the above disclosure, it is noted that the terms PCI conflict, PCI confusion, and PCI ambiguity are used to refer to the same or similar concepts and situations, and should be understood to refer to substantially the same situation, in some embodiments. In the above disclosure, it is noted that PCI confusion detection refers to a concept separate from PCI disambiguation, and should be read separately in relation to some embodiments. Power level, as referred to above, may refer to RSSI, RSFP, or any other signal strength indication or parameter. In the above disclosure, any specific identifier may be understood to be equivalent to another identifier serving the same function or compliant with a newer version of the relevant protocol.

In some embodiments, the software needed for implementing the methods and procedures described herein may be implemented in a high level procedural or an object-oriented language such as C, C++, C#, Python, Java, or Perl. The software may also be implemented in assembly language if desired. Packet processing implemented in a network device can include any processing determined by the context. For example, packet processing may involve high-level data link control (HDLC) framing, header compression, and/or encryption. In some embodiments, software that, when executed, causes a device to perform the methods described herein may be stored on a computer-readable medium such as read-only memory (ROM), programmable-read-only memory (PROM), electrically erasable programmable-read-only memory (EEPROM), flash memory, or a magnetic disk that is readable by a general or special purpose-processing unit to perform the processes described in this document. The processors can include any microprocessor (single or multiple core), system on chip (SoC), microcontroller, digital signal processor (DSP), graphics processing unit (GPU), or any other integrated circuit capable of processing instructions such as an x86 microprocessor.

In some embodiments, the radio transceivers described herein may be base stations compatible with a Long Term Evolution (LTE) radio transmission protocol or air interface. The LTE-compatible base stations may be eNodeBs. In addition to supporting the LTE protocol, the base stations may also support other air interfaces, such as UMTS/HSPA, CDMA/CDMA2000, GSM/EDGE, GPRS, EVDO, other 3G/2G, 5G, legacy TDD, or other air interfaces used for mobile telephony. 5G core networks that are standalone or non-standalone have been considered by the inventors as supported by the present disclosure.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols including 5G, or other air interfaces.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. The methods may apply to LTE-compatible networks, to UMTS-compatible networks, to 5G networks, or to networks for additional protocols that utilize radio frequency data transmission. Various components in the devices described herein may be added, removed, split across different devices, combined onto a single device, or substituted with those having the same or similar functionality.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Features of one embodiment may be used in another embodiment. Other embodiments are within the following claims.

1. A method for providing scalable and secured connectivity per Internet Protocol Security (IPSEC) tunnel, comprising:
spreading Encapsulating Security Payload (ESP) encryption for a same IPSEC tunnel across multiple backend application servers; and
processing application flows using decrypted packets by embedding the Application Server instance-id in ESP and application packets for correlation with application packet flows.

2. The method of claim 1 wherein spreading Encapsulating Security Payload (ESP) encryption for a same IPSEC tunnel across multiple backend application servers includes using multiple equal number of security associations (SAs) as a number of backend Applications servers.

3. The method of claim 2 further comprising rekeying to add more sets of pair of security association scaling and to add more backend application servers.

4. The method of claim 3 further comprising feeding Application-Data to the Application-server hosting the application flows for this application-data packet.

5. The method of claim 4 wherein feeding Application-Data to the Application-server hosting the application flows includes embedding the server-instance-id in a TE-Id for GTPU packets.

6. The method of claim 4 wherein feeding Application-Data to the Application-server hosting the application flows includes embedding the server-instance-id in a verification-tag for SCTP packets.

7. The method of claim 1 further comprising using a load balancer to host sets of Virtual IP-address (VIP) to distribute the traffic to backend-servers.

8. A system for providing scalable and secured connectivity per Internet Protocol Security (IPSEC) tunnel, comprising:
an IPSEC control element exchanging IPSEC signaling with a peer;
a traffic load balancer in communication with the IPSEC control element and receiving IPSEC ESP packets from the peer;
a plurality of Application servers in communication with the IPSEC control element and in communication with the load balancer;
wherein the system spreads Encapsulating Security Payload (ESP) encryption for a same IPSEC tunnel across the plurality of backend application servers; and
wherein the system processes application flows using decrypted packets by embedding the Application Server instance-id in ESP and application packets for correlation with application packet flows.

9. The system of claim 8 wherein spread of Encapsulating Security Payload (ESP) encryption for a same IPSEC tunnel across the plurality of backend application servers includes using multiple equal number of security associations (SAs) as a number of backend Applications servers.

10. The system of claim 9 further comprising rekeying to add more sets of pair of security association scaling and to add more backend application servers.

11. The system of claim 10 further comprising feeding Application-Data to the Application-server hosting the application flows for this application-data packet.

12. The system of claim 11 wherein feeding Application-Data to the Application-server hosting the application flows includes embedding the server-instance-id in a TE-Id for GTPU packets.

13. The system of claim 11 wherein feeding Application-Data to the Application-server hosting the application flows includes embedding the server-instance-id in a verification-tag for SCTP packets.

14. The system of claim 8 further comprising a load balancer used to host sets of Virtual IP-address (VIP) to distribute the traffic to backend-servers.

15. A non-transitory computer-readable medium containing instructions for providing scalable and secured connectivity per Internet Protocol Security (IPSEC) tunnel which, when executed, cause the system to perform steps comprising:
spreading Encapsulating Security Payload (ESP) encryption for a same IPSEC tunnel across multiple backend application servers; and
processing application flows using decrypted packets by embedding the Application Server instance-id in ESP and application packets for correlation with application packet flows.

16. The non-transitory computer-readable medium of claim 15 wherein instructions for spreading Encapsulating Security Payload (ESP) encryption for a same IPSEC tunnel across multiple backend application servers includes instructions for using multiple equal number of security associations (SAs) as a number of backend Applications servers.

17. The non-transitory computer-readable medium of claim 16 further comprising instructions for rekeying to add more sets of pair of security association scaling and instructions for to add more backend application servers.

18. The non-transitory computer-readable medium of claim 17 further comprising instructions for feeding Application-Data to the Application-server hosting the application flows for this application-data packet.

19. The method of claim 18 wherein the instructions for feeding Application-Data to the Application-server hosting the application flows includes instructions for embedding the server-instance-id in a TE-Id for GTPU packets or wherein the feeding Application-Data to the Application-server hosting the application flows includes instructions for embedding the server-instance-id in a verification-tag for SCTP packets.

20. The non-transitory computer-readable medium of claim 15 further comprising instructions for using a load balancer to host sets of Virtual IP-address (VIP) to distribute the traffic to backend-servers.
